(19) United States
(12) Patent Application Publication
(10) Pub. No.: US 2026/0116471 A1
(43) Pub. Date: Apr. 30, 2026

(54) VEHICLE FRONT SIDE MEMBER ASSEMBLY

(71) Applicants: HYUNDAI MOTOR COMPANY, Seoul (KR); KIA CORPORATION, Seoul (KR)

(72) Inventor: Jong Seop Song, Hwaseong-si (KR)

(73) Assignees: HYUNDAI MOTOR COMPANY, Seoul (KR); KIA CORPORATION, Seoul (KR)

(21) Appl. No.: 19/187,388

(22) Filed: Apr. 23, 2025

(30) Foreign Application Priority Data
Oct. 31, 2024 (KR) 10-2024-0152948

(51) Int. Cl. B62D 21/15

(52) U.S. Cl. CPC B62D 21/155

(57) ABSTRACT

A vehicle front side member assembly includes: a front side member extending in a longitudinal direction of a vehicle and configured to define a cavity therein; and a main reinforcing member positioned in the cavity of the front side member and including an angled portion.

### CROSS-REFERENCE TO RELATED APPLICATION

This application claims the benefit of and priority to Korean Patent Application No. 10-2024-0152948, filed on Oct. 31, 2024, in the Korean Intellectual Property Office, the disclosure of which is incorporated herein in its entirety by reference.

### TECHNICAL FIELD

The present disclosure relates to a vehicle front side member assembly, and more particularly, to a vehicle front side member assembly designed to mitigate passenger injuries in the event of a vehicle collision.

### BACKGROUND

In recent years, various types of vehicles such as a multi-purpose vehicle (MPV) and an electric vehicle may incorporate a cab-forward design enhance interior space and improve performance.

Compared to an existing vehicle design, the cab-forward design may position a cowl panel further forward, resulting in a relatively shorter front overhang.

In addition, a windshield glass may be positioned further forward in alignment with the cowl panel to accommodate the cab-forward design (e.g., matching the windshield glass to align with the cowl panel for the cab forward design), and it may be required to comply with domestic/North American windshield regulations. The regulations are intended to prevent windshield damage in order to ensure structural support for airbag deployment in the event of a collision/impact. The airbag should be developed to reduce the amount of body deformation (dynamic deformation) in the event of a vehicle collision. When the amount of body deformation is reduced, the vehicle body may absorb less impact energy, and the remaining impact energy may be transferred to a passenger compartment (cabin). Accordingly, it is desired to reduce the deformation of the vehicle body (i.e., vehicle body deformation) sufficiently to prevent the windshield damage.

Since an existing front side member assembly has a variation in body deformation during a collision, it may be difficult to undergo uniform deformation while complying with the regulations.

The above information described in this background section is provided to assist in understanding the background of the inventive concept, and may include any technical concept which is not considered as the prior art that is already known to those having ordinary skill in the art.

### SUMMARY

The present disclosure has been made to solve the above-mentioned problems occurring in the prior art while advantages achieved by the prior art are maintained intact.

An aspect of the present disclosure provides a vehicle front side member assembly designed to induce controlled or uniform deformation of a vehicle body during a vehicle collision/impact, thereby significantly reducing passenger injuries.

According to an aspect of the present disclosure, a vehicle front side member assembly may include: a front side member extending in a longitudinal direction of a vehicle and configured to define a cavity therein; and a main reinforcing member positioned in the cavity of the front side member, and including an angled portion.

The front side member may have a recessed portion, and the recessed portion may face the angled portion of the main reinforcing member.

The vehicle front side member assembly may further include an auxiliary reinforcing member attached to the angled portion of the main reinforcing member.

The angled portion of the main reinforcing member may have a V-shaped configuration.

The main reinforcing member may include a front inclined wall and a rear inclined wall positioned opposite the front inclined wall. The front inclined wall and the rear inclined wall may form the V-shaped angled portion.

The front inclined wall and the rear inclined wall may have a symmetrical shape with respect to the recessed portion of the front side member.

The main reinforcing member may further include: a front flat wall extending from the front inclined wall toward a front end of the front side member; and a rear flat wall extending from the rear inclined wall toward a rear end of the front side member. The front flat wall and the rear flat wall may be fixed to the front side member.

The vehicle front side member assembly may further include: front mounting hardware provided on a front portion of the front side member; and rear mounting hardware provided on a rear portion of the front side member.

The vehicle front side member assembly may further include: a front bulkhead aligned with the front mounting hardware; and a rear bulkhead aligned with the rear mounting hardware.

The front mounting hardware may be fixed to the front bulkhead, and the rear mounting hardware may be fixed to the rear bulkhead.

The angled portion of the main reinforcing member may have a W-shaped configuration.

In an embodiment of the present disclosure, a vehicle front side member assembly comprises a front side member extending in a longitudinal direction of a vehicle. The front side member is configured to define an internal space. The vehicle front side member assembly further includes: a main reinforcing member positioned in the internal space of the front side member and including a pair of walls connected to form an angle; and a cover fixed to the front side member and configured to close the internal space of the front side member. In particular, the pair of walls are fixed to the cover and the front side member and configured to absorb an external impact energy.

In an embodiment, the pair of side walls comprises: a first wall; and a second wall positioned opposite the first wall. The first and second walls are configured to form a V-shaped structure.

In another embodiment, the main reinforcing member further incudes a middle flat wall disposed between and fixed to the first wall and the second wall. The main reinforcing member further incudes: a front flat wall extending from the first wall toward a front end of the front side member; and a rear flat wall extending from the second wall toward a rear end of the front side member. In particular, the front flat wall and the rear flat wall are fixed to the front side member and the middle flat wall is fixed to the cover.

In another embodiment, the vehicle front side member assembly further includes an auxiliary reinforcing member attached to the pair of walls of the main reinforcing member.

In an embodiment, the front side member comprises a first deformable portion configured to induce a deformation of the front side member in response to the external impact energy. The auxiliary reinforcing member is positioned between the pair of walls of the main reinforcing member and comprises a second deformable portion configured to induce a deformation of the auxiliary reinforcing member in response to the external impact energy. In particular, the first deformable portion of the front side member is aligned with the second deformable portion of the auxiliary reinforcing member.

### BRIEF DESCRIPTION OF THE DRAWINGS

The above and other objects, features and advantages of the present disclosure should be more apparent from the following detailed description taken in conjunction with the accompanying drawings:

FIG. 1 illustrates a perspective view of a vehicle front side member assembly according to an embodiment of the present disclosure;

FIG. 2 illustrates a bottom view, viewed from a direction indicated by arrow A of FIG. 1;

FIG. 3 illustrates an exploded perspective view of a vehicle front side member assembly according to an embodiment of the present disclosure;

FIG. 4 illustrates a bottom view of vehicle front side member assemblies, according to an embodiment of the present disclosure, which are attached to the front portion of the vehicle;

FIG. 5 illustrates a side view of a vehicle front side member assembly, according to an embodiment of the present disclosure, which is mounted on the front portion of the vehicle; and

FIG. 6 illustrates a perspective view of a vehicle front side member assembly according to another embodiment of the present disclosure.

### DETAILED DESCRIPTION

Hereinafter, some embodiments of the present disclosure are described in detail with reference to the accompanying drawings. In the drawings, the same reference numerals are used to designate the same or equivalent elements. In addition, a detailed description of well-known techniques associated with the present disclosure is ruled out in order not to unnecessarily obscure the gist of the present disclosure.

Terms such as first, second, A, B, (a), and (b) may be used to describe the elements in embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present disclosure.

When a component, device, element, or the like of the present disclosure is described as having a purpose or performing an operation, function, or the like, the component, device, or element should be considered herein as being “configured to” meet that purpose or to perform that operation or function.

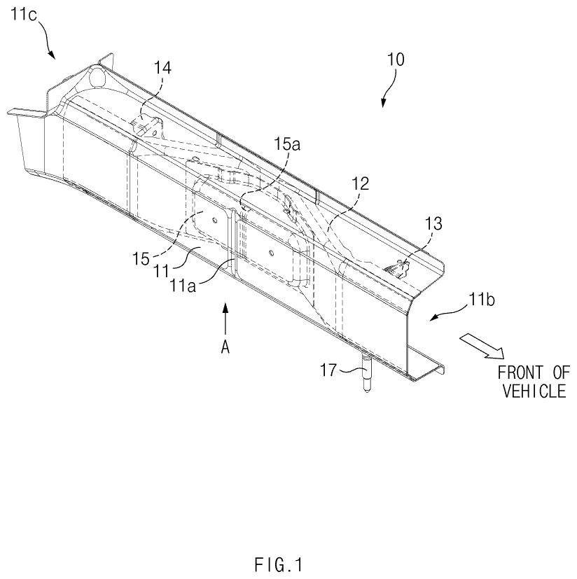

According to an embodiment of the present disclosure, as illustrated in FIG. 1, a vehicle front side member assembly 10 may include: a front side member 11 extending in a longitudinal direction of a vehicle body, and a main reinforcing member 12 disposed in an internal space (e.g., a cavity 11d) of the front side member 11 and configured to deform.

The front side member 11 may define the cavity 11d therein. The front side member 11 may include an inboard wall facing the interior of the vehicle, a top wall facing the top of the vehicle, and a bottom wall facing the bottom of the vehicle. The inboard wall, the top wall, and the bottom wall of the front side member 11 may extend in the longitudinal direction of the vehicle, and the cavity 11d of the front side member 11 may be defined by the inboard wall, the top wall, and the bottom wall, and the cavity 11d is open to the exterior of the vehicle.

Referring to FIGS. 1 to 3, the front side member 11 may have a recessed portion 11a (i.e., a first deformable portion) provided in the inboard wall, and the recessed portion 11a may extend in a height direction of the vehicle. In the event of a vehicle collision/impact, the front side member 11 may be readily deformable at the recessed portion 11a. In other words, the front side member 11 may be configured to facilitate deformation at the recessed portion to enhance energy absorption during an impact. The recessed portion 11a may be formed at a position to induce a deformation of the front side member 11. For example, the recessed portion 11a may be formed in a middle portion of the front side member 11.

The front side member 11 may include a front end 11b facing the front of the vehicle, and a rear end 11c facing the rear of the vehicle.

The main reinforcing member 12 may be positioned or mounted in the cavity 11d of the front side member 11, and the main reinforcing member 12 may extend in a longitudinal direction of the front side member 11. The main reinforcing member 12 may include an angled portion, and the angled portion may have a V-shaped configuration. The angled portion may be positioned at a predetermined location on the main reinforcing member 12 to induce deformation of the front side member 11. When impact energy is transferred to the front side member 11 during a vehicle collision/impact, the main reinforcing member 12 may be deformed at the V-shaped angled portion, such that uniform and controlled deformation of the front side member 11 may be induced.

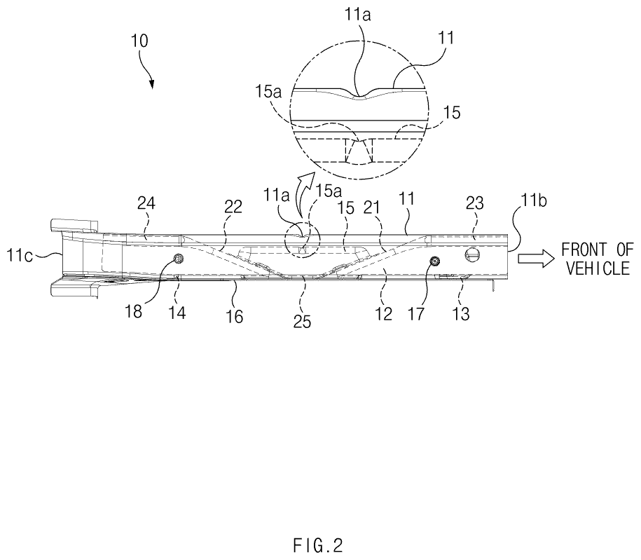

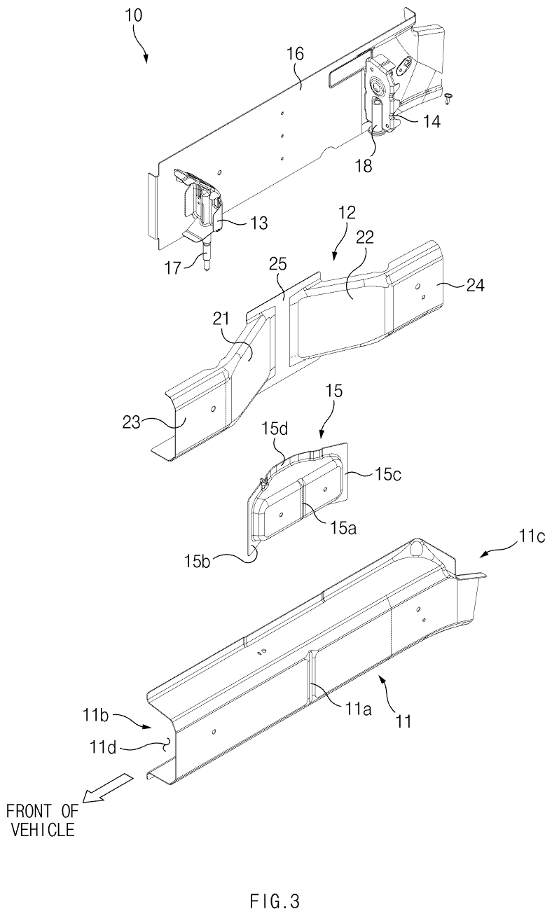

Referring to FIGS. 2 and 3, the main reinforcing member 12 may include a pair of walls connected to form an angle. The pair of walls includes a first wall 21 (e.g., a front inclined wall) adjacent to the front end 11b of the front side member 11, and a second wall 22 (e.g., a rear inclined wall) adjacent to the rear end 11c of the front side member 11. The front inclined wall 21 may be positioned opposite the rear inclined wall 22 so that the front inclined wall 21 and the rear inclined wall 22 may form the V-shaped angled portion, and the front inclined wall 21 may be symmetrical to the rear inclined wall 22.

The recessed portion 11a of the front side member 11 may be formed along a width direction of the front side member 11 and face the angled portion of the main reinforcing member 12. Referring to FIG. 2, the front inclined wall 21 and the rear inclined wall 22 may have a symmetrical shape with respect to the recessed portion 11a of the front side member 11.

Referring to FIGS. 2 and 3, the main reinforcing member 12 may further include a front flat wall 23 extending from the front inclined wall 21 toward the front end 11b of the front side member 11, and a rear flat wall 24 extending from the rear inclined wall 22 toward the rear end 11c of the front side member 11. The front flat wall 23 and the rear flat wall 24 may be fixed to the front side member 11 using fasteners, welding, and/or the like.

Referring to FIG. 3, according to an embodiment of the present disclosure, the vehicle front side member assembly 10 may include a cover 16 covering the open portion (i.e., the internal space) of the front side member 11. The cover 16 may be a plate extending in the longitudinal direction of the front side member 11, and the cover 16 may be fixed to the front side member 11 using fasteners, welding, and/or the like so that the open portion of the front side member 11 may be covered.

Referring to FIGS. 2 and 3, the main reinforcing member 12 may further include a middle flat wall 25 located between the front inclined wall 21 and the rear inclined wall 22. The middle flat wall 25 may be fixed to the cover 16.

Referring to FIG. 2, the recessed portion 11a of the front side member 11 may be aligned with a middle portion of the middle flat wall 25 of the main reinforcing member 12 in the width direction of the front side member 11.

Referring to FIGS. 1 and 2, according to an embodiment of the present disclosure, the vehicle front side member assembly 10 may further include front mounting hardware 17 provided on a front portion of the front side member 11, and rear mounting hardware 18 provided on a rear portion of the front side member 11. The mounting hardware 17, 18 refers to mechanical components (e.g., bolts, nuts, brackets, fasteners, or connectors) used to attach or fasten parts together.

Referring to FIG. 2, the front mounting hardware 17 and the rear mounting hardware 18 may be provided on the bottom wall of the front side member 11. According to an embodiment, the front mounting hardware 17 may be a stud bolt protruding downward from the bottom wall of the front portion of the front side member 11. The rear mounting hardware 18 may be a nut mounted on the bottom wall of the rear portion of the front side member 11.

Referring to FIGS. 1 and 3, according to an embodiment of the present disclosure, the vehicle front side member assembly 10 may further include a front bulkhead 13 and a rear bulkhead 14 provided in the cavity 11d of the front side member 11. The front bulkhead 13 and the rear bulkhead 14 may be fixed to the front side member 11 and the cover 16 using fasteners, welding, and/or the like.

The front bulkhead 13 may be aligned with the front mounting hardware 17, and the rear bulkhead 14 may be aligned with the rear mounting hardware 18. Referring to FIG. 3, the front mounting hardware 17 may be fixed to the front bulkhead 13, and accordingly the front mounting hardware 17 may be firmly fixed to the front portion of the front side member 11 by the front bulkhead 13. The rear mounting hardware 18 may be fixed to the rear bulkhead 14, and accordingly the rear mounting hardware 18 may be firmly fixed to the rear portion of the front side member 11 by the rear bulkhead 14.

Referring to FIGS. 1 and 2, according to an embodiment of the present disclosure, the vehicle front side member assembly 10 may further include an auxiliary reinforcing member 15 mounted on the angled portion of the main reinforcing member 12.

The auxiliary reinforcing member 15 may have a sidewall extending in parallel to the inboard wall of the front side member 11 on the angled portion of the main reinforcing member 12, such that the auxiliary reinforcing member 15 may be mounted on the angled portion of the main reinforcing member 12. With this configuration, the auxiliary reinforcing member 15 may prevent the front side member 11 from being excessively deformed by the angled portion of the main reinforcing member 12, and the auxiliary reinforcing member 15 may absorb the impact energy transferred to the main reinforcing member 12 during a vehicle collision/impact. Accordingly, when the impact energy is transferred to the front side member 11 and the main reinforcing member 12, the auxiliary reinforcing member 15 may be configured to support the front side member 11 in achieving a controlled deformation mode in response to the impact energy.

Referring to FIG. 3, the auxiliary reinforcing member 15 may include a front flange 15b fixed to the front inclined wall 21 of the main reinforcing member 12, a rear flange 15c fixed to the rear inclined wall 22 of the main reinforcing member 12, and a middle flange 15d fixed to the middle flat wall 25 of the main reinforcing member 12.

Referring to FIG. 3, the auxiliary reinforcing member 15 may have a recessed portion 15a (i.e., a second deformable portion), and the recessed portion 15a may extend in a width direction of the auxiliary reinforcing member 15. Referring to FIG. 2, the recessed portion 15a of the auxiliary reinforcing member 15 may be aligned with the recessed portion 11a of the front side member 11. Accordingly, the recessed portion 15a of the auxiliary reinforcing member 15 may induce the deformation of the auxiliary reinforcing member 15.

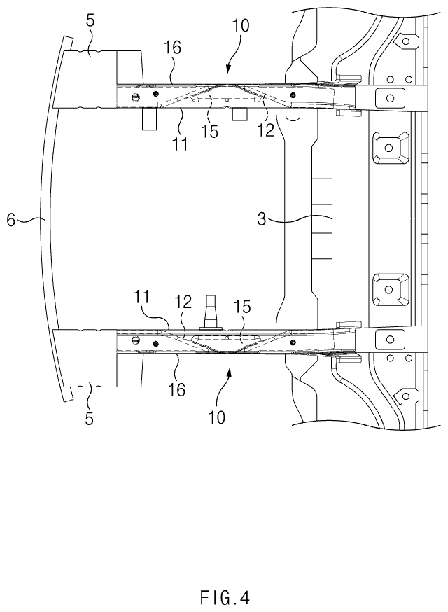

Referring to FIG. 4, the pair of front side member assemblies 10 may be disposed on the front of the vehicle body, and each front side member assembly 10 may extend from a dash panel 3 toward the front of the vehicle. The rear end of the front side member 11 of each front side member assembly 10 may be fixed to the dash panel 3, and the front end of the front side member 11 may be fixed to a crash box 5. A front bumper 6 may be mounted in a transverse orientation relative to the pair of crash boxes 5 to distribute impact forces.

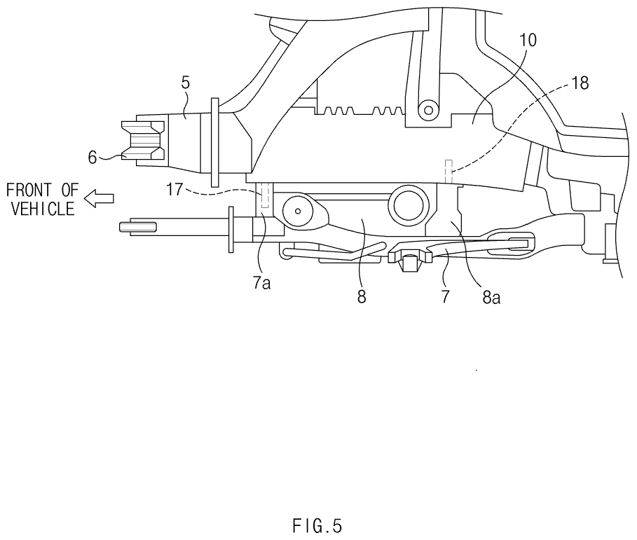

Referring to FIG. 5, a front mount 7a for a front subframe 7 may be mounted on the front mounting hardware 17, and a mount 8a for a power electronics (PE) component 8 may be mounted on the rear mounting hardware 18.

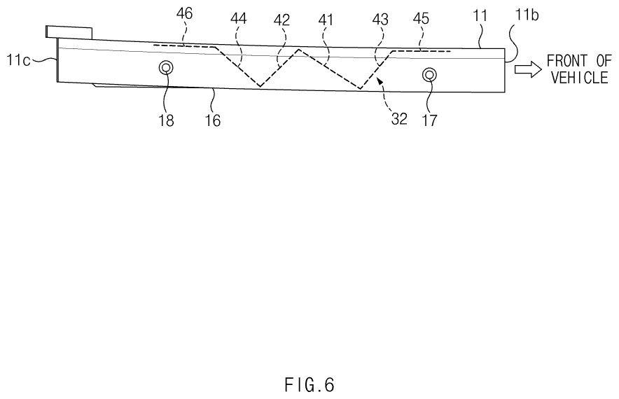

FIG. 6 illustrates a main reinforcing member 32 including an angled portion having a W-shaped configuration in a vehicle front side member assembly according to a modified embodiment of the present disclosure. Referring to FIG. 6, the main reinforcing member 32 may include: a first front inclined wall 41, a second front inclined wall 43 symmetrically connected to the first front inclined wall 41, a front flat wall 45 extending from the second front inclined wall 43 toward the front of the vehicle, a first rear inclined wall 42 symmetrically connected to the first front inclined wall 41, a second rear inclined wall 44 symmetrically connected to the first rear inclined wall 42, and a rear flat wall 46 extending from the second rear inclined wall 44 toward the rear of the vehicle.

Accordingly, the main reinforcing member 32 may have a W-shaped angled portion formed by the first front inclined wall 41, the second front inclined wall 43, the first rear inclined wall 42, and the second rear inclined wall 44. When the impact energy is transferred to the front side member 11 during a vehicle collision/impact, the main reinforcing member 32 may be deformed at or the W-shaped angled portion. Accordingly, a consistent controlled deformation of the front side member 11 may be induced.

According to an embodiment, a front auxiliary reinforcing member may be mounted between the first front inclined wall 41 and the second front inclined wall 43, and a rear auxiliary reinforcing member may be mounted between the first rear inclined wall 42 and the second rear inclined wall 44.

According to the above-described embodiments of the present disclosure, the main reinforcing member having the angled portion and the auxiliary reinforcing member may induce the uniform or controlled deformation of the front side member, and efficiently absorb the impact energy. The material, thickness, and the like of the main reinforcing member 12 or 32 and/or the auxiliary reinforcing member 15 may be determined based on the required or allowed amount of deformation of the vehicle body.

According to the embodiments of the present disclosure, the front side member assembly may be designed to include the main reinforcing member with the angled portion positioned in the cavity 11d of the front side member so that the front side member assembly may induce a predictable and uniform deformation pattern of the vehicle body during the vehicle collision or impact, thereby significantly reducing or minimizing passenger injuries.

According to embodiments of the present disclosure, the auxiliary reinforcing member may be mounted on the angled portion of the deformable main reinforcing member so that excessive deformation of the front side member may be prevented, and the auxiliary reinforcing member may absorb the impact energy so that crashworthiness of the vehicle body may be improved.

Hereinabove, although the present disclosure has been described with reference to some embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A vehicle front side member assembly, comprising:
a front side member extending in a longitudinal direction of a vehicle, the front side member configured to define a cavity therein; and
a main reinforcing member positioned in the cavity of the front side member and including an angled portion.

2. The vehicle front side member assembly according to claim 1, wherein the front side member includes a recessed portion, and
the recessed portion faces the angled portion of the main reinforcing member.

3. The vehicle front side member assembly according to claim 1, further comprising an auxiliary reinforcing member attached to the angled portion of the main reinforcing member.

4. The vehicle front side member assembly according to claim 2, wherein the angled portion of the main reinforcing member has a V-shaped configuration.

5. The vehicle front side member assembly according to claim 4, wherein the main reinforcing member comprises a front inclined wall and a rear inclined wall positioned opposite the front inclined wall, and
the front inclined wall and the rear inclined wall form the angled portion.

6. The vehicle front side member assembly according to claim 5, wherein the front inclined wall and the rear inclined wall have a symmetrical shape with respect to the recessed portion of the front side member.

7. The vehicle front side member assembly according to claim 5, wherein the main reinforcing member further comprises: a front flat wall extending from the front inclined wall toward a front end of the front side member, and a rear flat wall extending from the rear inclined wall toward a rear end of the front side member, and
the front flat wall and the rear flat wall are fixed to the front side member.

8. The vehicle front side member assembly according to claim 1, further comprising:
front mounting hardware provided on a front portion of the front side member; and
rear mounting hardware provided on a rear portion of the front side member.

9. The vehicle front side member assembly according to claim 8, further comprising:
a front bulkhead aligned with the front mounting hardware; and
a rear bulkhead aligned with the rear mounting hardware.

10. The vehicle front side member assembly according to claim 9, wherein the front mounting hardware is fixed to the front bulkhead, and
the rear mounting hardware is fixed to the rear bulkhead.

11. The vehicle front side member assembly according to claim 1, wherein the angled portion of the main reinforcing member has a W-shaped configuration.

12. A vehicle front side member assembly, comprising:
a front side member extending in a longitudinal direction of a vehicle, the front side member configured to define an internal space;
a main reinforcing member positioned in the internal space of the front side member and including a pair of walls connected to form an angle; and
a cover fixed to the front side member and configured to close the internal space of the front side member,
wherein the pair of walls are fixed to the cover and the front side member and configured to absorb an external impact energy.

13. The vehicle front side member assembly according to claim 12, wherein the pair of side walls comprises:
a first wall; and
a second wall positioned opposite the first wall,
wherein the first and second walls are configured to form a V-shaped structure.

14. The vehicle front side member assembly according to claim 13, wherein the main reinforcing member further comprises:
a middle flat wall disposed between and fixed to the first wall and the second wall;
a front flat wall extending from the first wall toward a front end of the front side member; and
a rear flat wall extending from the second wall toward a rear end of the front side member, and
wherein the front flat wall and the rear flat wall are fixed to the front side member and the middle flat wall is fixed to the cover.

15. The vehicle front side member assembly according to claim 12, further comprising an auxiliary reinforcing member attached to the pair of walls of the main reinforcing member.

16. The vehicle front side member assembly according to claim 15, wherein the auxiliary reinforcing member comprises a deformable portion configured to induce a deformation of the auxiliary reinforcing member in response to the external impact energy.

17. The vehicle front side member assembly according to claim 15, wherein the front side member comprises a first deformable portion configured to induce a deformation of the front side member in response to the external impact energy, and
wherein the auxiliary reinforcing member is positioned between the pair of walls of the main reinforcing member and comprises a second deformable portion configured to induce a deformation of the auxiliary reinforcing member in response to the external impact energy.

18. The vehicle front side member assembly according to claim 17, wherein the first deformable portion of the front side member is aligned with the second deformable portion of the auxiliary reinforcing member.
